(19) United States
(12) Patent Application Publication
(10) Pub. No.: US 2014/0327695 A1
(43) Pub. Date: Nov. 6, 2014

(54) IMAGE PROCESSING APPARATUS AND CONTROL METHOD THEREFOR

(71) Applicant: CANON KABUSHIKI KAISHA, Tokyo (JP)

(72) Inventor: Yasuo Suzuki, Yokohama-shi (JP)

(73) Assignee: CANON KABUSHIKI KAISHA, Tokyo (JP)

(21) Appl. No.: 14/260,513

(22) Filed: Apr. 24, 2014

(30) Foreign Application Priority Data
May 1, 2013 (JP) 2013-096349

(51) Int. Cl. G09G 5/06

(52) U.S. Cl. CPC G09G 5/06
USPC 345/601

(57) ABSTRACT

An image processing apparatus according to the present invention comprises a generation unit configured to generate a lookup table having a specific number of lattice points for converting input image data into display image data having a different gradation characteristic by using a predetermined expression and a conversion unit configured to convert the input image data into the display image data by using the lookup table generated by the generation unit. The generation unit determines positions of the specific number of lattice points in accordance with a dynamic range of the input image data.

### BACKGROUND OF THE INVENTION

1. Field of the Invention

The present invention relates to an image processing apparatus and a control method for the image processing apparatus.

2. Description of the Related Art

Conventionally, imaging data taken by an imaging apparatus has been subjected to, e.g., gamma compensation processing that considers a characteristic defined by ITU-R BT. 709 (a gamma characteristic of a CRT), and has been outputted. The gamma compensation processing is, e.g., processing that converts imaging data to image data (gamma compensation processing data) with a conversion characteristic (a photoelectric conversion characteristic) represented by Expression 1 shown below. In Expression 1, X denotes the imaging data, while Y denotes the gamma compensation processing data. Expression 1 is an example in the case where Y is a value expressed in 8-bit 256 gradations.

Y=255×(X/255)^{0.45} (Expression 1)

On the other hand, in recent years, with an improvement in the light receiving performance of the imaging apparatus, the imaging apparatus that outputs image data having a gradation characteristic close to Log in order to handle a signal having a wider dynamic range has begun to appear. For example, at a movie making site, Cineon Log image data corresponding to the characteristic of a film having a wide dynamic range is used.

Further, there is known the imaging apparatus that allows a user to adjust the dynamic range of the image data (the dynamic range of the image data obtained by conversion of the imaging data) outputted from the imaging apparatus. The user can adjust the dynamic range of the image data within the range of the light receiving performance.

In addition, as a display apparatus, there is known an apparatus that converts the gradation characteristic of the image data in order to precisely display the image data (input image data inputted into the display apparatus) outputted from the imaging apparatus. It is known that the conversion of the gradation characteristic mentioned above is performed by using a predetermined lookup table (LUT).

In order to reduce a circuit scale, as a lattice point of the LUT (a combination of an input gradation value and an output gradation value), it is general to set the lattice points smaller in number than the gradation values that the input image data can have instead of setting the lattice point for each of the gradation values that the input image data can have. That is, it is general to use the LUT generated with thinning of the gradation values that the input image data can have. The output gradation value corresponding to the input gradation value between the lattice points is calculated by interpolation using the lattice point (interpolation or extrapolation).

Examples of the related art related to the conversion of the gradation characteristic using the LUT include a technology for performing gradation expression on a dark part side with high accuracy and a technology for allowing handling of the input image data having various gradation characteristics.

Specifically, there is proposed a technology for rewriting the output gradation value corresponding the each lattice point of the predetermined LUT (Japanese Patent Application Laid-open No. 2008-301381).

When the technology disclosed in Japanese Patent Application Laid-open No. 2008-301381 is used, it becomes possible to handle the input image data having various gradation characteristics by rewriting the output gradation value of each lattice point such that the output gradation value corresponds to the input image data.

In the imaging apparatus capable of handling the signal having the wide dynamic range, in many cases, the dynamic range of the input image data is adjusted and the image data corresponding to the conventional dynamic range is outputted for the convenience of its operation. However, as in the technology disclosed in Japanese Patent Application Laid-open No. 2008-301381, the input gradation value of the lattice point is a fixed value in the related art. Accordingly, in the related art, there are cases where it is not possible to perform the conversion of the gradation characteristic of the input image data with high accuracy depending on the dynamic range of the input image data. For example, in the case where the dynamic range of the input image data is adjusted, there are cases where a part of the lattice points of the LUT is not used in the conversion of the gradation characteristic, and the number of the lattice points to be used is reduced. As a result, there are cases where a conversion error (specifically, an interpolation error) becomes non-negligible, and the image quality of a display image is significantly degraded.

### SUMMARY OF THE INVENTION

The present invention provides a technology for allowing execution of conversion of the gradation characteristic of the input image data with high accuracy irrespective of the dynamic range of the input image data.

The present invention in its first aspect provides an image processing apparatus comprising:

a generation unit configured to generate a lookup table having a specific number of lattice points for converting input image data into display image data having a different gradation characteristic by using a predetermined expression; and

a conversion unit configured to convert the input image data into the display image data by using the lookup table generated by the generation unit, wherein

the generation unit determines positions of the specific number of lattice points in accordance with a dynamic range of the input image data.

The present invention in its second aspect provides a control method for an image processing apparatus comprising:

a generation step of generating a lookup table having a specific number of lattice points for converting input image data into display image data having a different gradation characteristic by using a predetermined expression; and

a conversion step of converting the input image data into the display image data by using the lookup table generated in the generation step, wherein

positions of the specific number of lattice points are determined in accordance with a dynamic range of the input image data in the generation step.

The present invention in its third aspect provides a non-transitory computer readable medium that stores a program, wherein the program causes a computer to execute the above mentioned method.

According to the present invention, conversion of the gradation characteristic of the input image data can be executed with high accuracy irrespective of the dynamic range of the input image data

Further features of the present invention will become apparent from the following description of exemplary embodiments with reference to the attached drawings.

### BRIEF DESCRIPTION OF THE DRAWINGS

FIG. 1 is a block diagram showing an example of the configuration of a display apparatus according to a first embodiment;

FIG. 2 is a view showing an example of a transmission method of image data according to the first embodiment;

each of FIGS. 3A and 3B is a view showing an example of processing of a common characteristic conversion unit according to the first embodiment;

FIG. 4 is a view showing an example of processing of a gradation characteristic conversion unit according to the first embodiment;

each of FIGS. 5A to 5E is a view showing an example of lattice points according to the first embodiment;

FIG. 6 is a block diagram showing an example of the configuration of the gradation characteristic conversion unit according to the first embodiment;

FIG. 7 is a view showing an example of input value data according to the first embodiment; and

FIG. 8 is a block diagram showing an example of the configuration of a display apparatus according to a second embodiment.

### DESCRIPTION OF THE EMBODIMENTS

### First Embodiment

Hereinbelow, a description will be given of an image processing apparatus and a control method for the image processing apparatus according to a first embodiment of the present invention with reference to the drawings.

The image processing apparatus according to the present embodiment is an apparatus into which image data having an arbitrary dynamic range can be inputted. For example, into the image processing apparatus according to the present embodiment, the following image data is inputted.
image data in which a dynamic range is a gradation range corresponding to the gradation range 0 to 100% of imaging data, a gradation value is an 8-bit gradation value, and a gradation characteristic is a gamma 2. 2 characteristic
image data in which the dynamic range is a gradation range corresponding to the gradation range 0 to 1000% of the imaging data, the gradation value is a 12-bit gradation value, and the gradation characteristic is a Log characteristic

In the present embodiment, a description will be given of a configuration that allows execution of conversion of the gradation characteristic of input image data with high accuracy irrespective of the dynamic range of the input image data.

Note that, in the present embodiment, although a description will be given of an example in the case where the image processing apparatus is provided in a display apparatus, the image processing apparatus may also be an apparatus separate from the display apparatus. For example, the image processing apparatus may be provided in a personal computer (PC) that is separate from the display apparatus. In addition, in the present embodiment, although a description will be given of an example in the case where the display apparatus is a liquid crystal display apparatus, the display apparatus is not limited to the liquid crystal display apparatus. For example, the display apparatus may be an organic EL display apparatus or a plasma display apparatus.

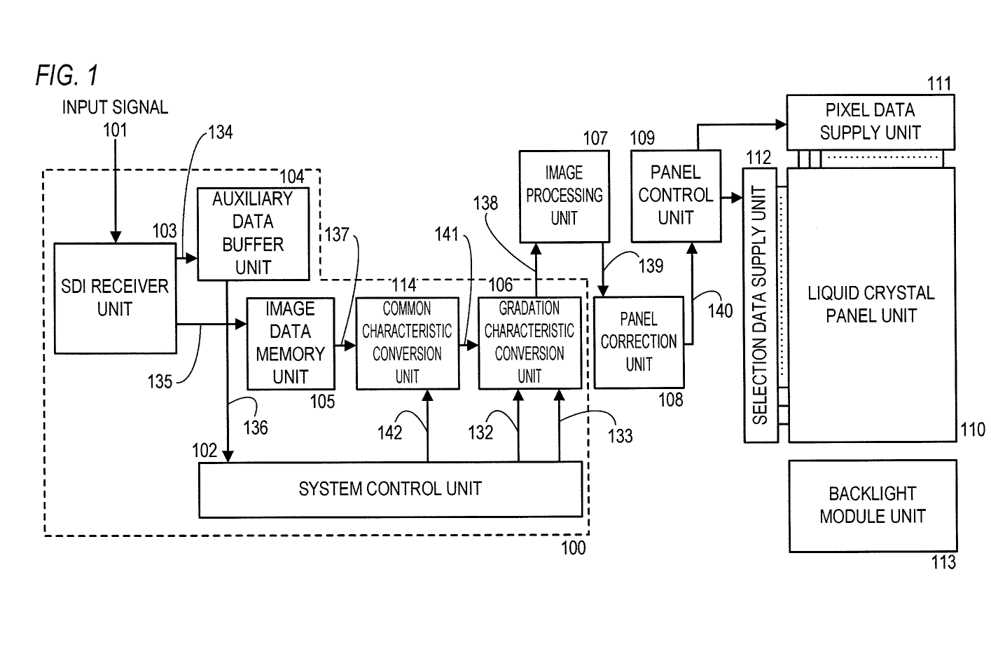

As shown in FIG. 1, the display apparatus according to the present embodiment includes an image processing apparatus 100, an image processing unit 107, a panel correction unit 108, a panel control unit 109, a liquid crystal panel unit 110, a pixel data supply unit 111, a selection data supply unit 112, and a backlight module unit 113. The image processing apparatus 100 includes a system control unit 102, an SDI receiver unit 103, an auxiliary data buffer unit 104, an image data memory unit 105, a common characteristic conversion unit 114, and a gradation characteristic conversion unit 106.

In the present embodiment, RGB image data is inputted into the display apparatus as input image data. The input image data is image data obtained by converting imaging data taken by an imaging apparatus, and has a dynamic range corresponding to the type of the imaging apparatus, an imaging condition, and a set mode.

Specifically, into the display apparatus, an input signal 101 is inputted by serial digital interface (SDI) transmission. According to a 3G-SDI signal defined by SMPTE425M, video data on which auxiliary data is superimposed can be transmitted. In the present embodiment, as the input signal 101, the input image data as the video data and the 3G-SDI signal including the auxiliary data are inputted. In the present embodiment, the auxiliary data includes D range information indicative of the dynamic range of the input image data.

Note that the image data is not limited to the RGB image data. For example, the image data may also be YCbCr image data.

Note that the input signal 101 is not limited to the above-mentioned 3G-SDI signal. The input signal 101 may be any signal as long as the signal includes the input image data and the D range information. In addition, the input image data and the D range information may be individually inputted.

The SDI receiver unit 103 acquires the input image data and the D range information. Specifically, the SDI receiver unit 103 acquires the input signal 101. Subsequently, the SDI receiver unit 103 separates the input signal 101 into the input image data as the video data and the auxiliary data including the D range information.

The auxiliary data buffer unit 104 stores the auxiliary data separated in the SDI receiver unit 103.

The image data memory unit 105 is a frame memory that stores the input image data separated in the SDI receiver unit 103.

Note that the input image data and the auxiliary data (the D range information) may be acquired by different functional units.

The system control unit 102 generates a lookup table (LUT) used for converting the input image data to display image data having the gradation characteristic different from that of the input image data.

In the present embodiment, as the LUT, the LUT having a specific number of (n (n is an integer not less than 2)) lattice points that are discretely provided is generated. The lattice point is the combination of an input gradation value and an output gradation value.

Specifically, the generation range of the lattice points (the gradation range in which n lattice points are generated) is determined so as to correspond to the dynamic range of the input image data based on the D range information, the position of each of the lattice points (the input gradation value and the output gradation value) is determined, and the LUT is thereby generated.

In the present embodiment, a one-dimensional lookup table is generated. Specifically, the input image data is the RGB image data and the D range information common to an R value, a G value, and a B value is acquired. Subsequently, the one-dimensional lookup table common to the R value, the G value, and the B value is generated. Note that gradation characteristics of the R value, the G value, and the B value may be different from each other. In this case, it is only necessary to acquire the D range information of each of the R value, the G value, and the B value and generate the one-dimensional lookup table for each of the R value, the G value, and the B value. The input image data may be the YCbCr image data, and the one-dimensional lookup table for converting the gradation characteristic of a Y value may be appropriately generated. A three-dimensional lookup table (e.g., the three-dimensional lookup table having the combination of the R value, the G value, and the B value as the input gradation value and the output gradation value) may also be generated.

The input image data is converted to the display image data (post-gradation conversion data) using the LUT generated in the system control unit 102 by the common characteristic conversion unit 114 and the gradation characteristic conversion unit 106.

The common characteristic conversion unit 114 converts the input image data having an arbitrary gradation characteristic to common gradation data (pre-gradation conversion data) as image data having the gradation characteristic for gradation conversion processing (gradation conversion processing using the above LUT) to the post-gradation conversion data.

The gradation characteristic conversion unit 106 converts the common gradation data to the post-gradation conversion data using the LUT generated in the system control unit 102. In the present embodiment, although the image data having various gradation characteristics is inputted as the input image data, for the purpose of simplifying the processing, it is assumed that the display apparatus is configured to input image data having a specific gradation characteristic into the image processing unit 107 in the subsequent stage. Specifically, the display apparatus is configured to input the image data having a gamma characteristic defined by ITU-R BT. 709 into the image processing unit 107. Accordingly, in the gradation characteristic conversion unit 106, the common gradation data is converted to the post-gradation conversion data having the gamma characteristic defined by ITU-R BT. 709.

Note that the gradation characteristic of the post-gradation conversion data is not limited to the gamma characteristic defined by ITU-R BT. 709. For example, the gradation characteristic of the post-gradation conversion data may also be a gradation characteristic defined by DCI.

The image processing unit 107 performs specific image processing on the post-gradation conversion data. The specific image processing is, e.g., processing that adjusts the brightness and color of a display image (an image displayed on a screen of the display apparatus). In the present embodiment, the image processing is performed by using an adjustment value set by a user, and the brightness and color of the display image are adjusted so as to be brought into desired states.

The liquid crystal panel unit 110 is a liquid crystal panel having a plurality of liquid crystal pixels arranged in a matrix. The transmittance of each liquid crystal pixel of the liquid crystal panel unit 110 is controlled by the panel correction unit 108, the panel control unit 109, the pixel data supply unit 111, and the selection data supply unit 112.

The backlight module unit 113 reflects light to (the back surface of) the liquid crystal panel unit 110. An image is displayed on the screen by the passage of the light from the backlight module unit 113 through the liquid crystal panel unit 110.

Hereinbelow, the operation of the display apparatus shown in FIG. 1 will be described in detail.

The input signal 101 is outputted from the imaging apparatus. In the present embodiment, it is assumed that the imaging apparatus has a plurality of image output modes having different dynamic ranges, and a camera user (a user of the imaging apparatus) switches the image output mode in accordance with the brightness and imaging condition of an imaging scene. The imaging apparatus converts the imaging data to the input image data as the image data having the dynamic range corresponding to the image output mode selected by the camera user. Subsequently, the imaging apparatus outputs the input signal 101 including the input image data as the video data and the auxiliary data. Herein, the auxiliary data includes the D range information indicative of the dynamic range corresponding to the selected image output mode. In addition, in the present embodiment, it is assumed that the auxiliary data includes not only the D range information but also gradation characteristic information that further indicates the bit number of the input image data and the type of the gradation characteristic.

Note that the gradation characteristic information may indicate the conversion characteristic from the imaging data to the input image data, in other words, the correspondence between the gradation value of the imaging data and the gradation value of the input image data instead of the bit number of the input image data and the type of the gradation characteristic.

### (Step 1)

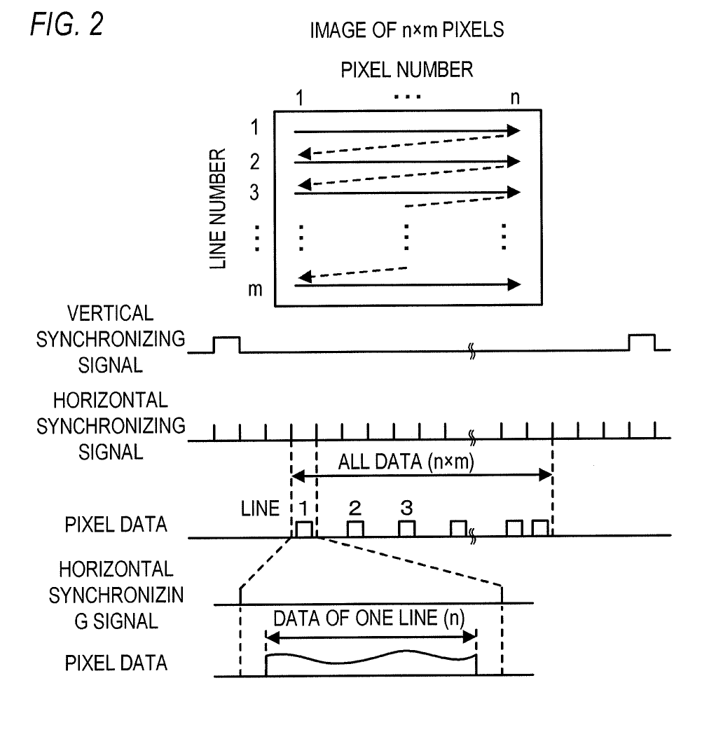

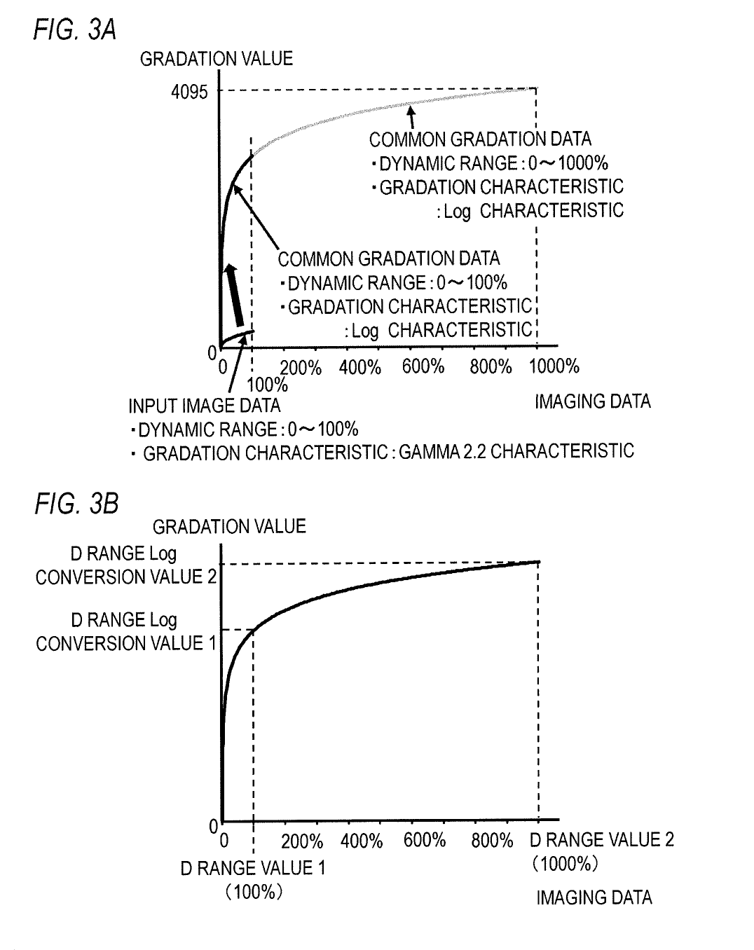

The SDI receiver unit 103 separates input image data 135 and auxiliary data 134 from the input signal 101 and outputs them. The image data is transmitted using, e.g., a raster system. The image data of the raster system is image data in which pixel data (a pixel value) is described for each pixel. In the present embodiment, the image data includes each pixel data, a vertical synchronizing signal indicative of the start of an image, and a horizontal synchronizing signal indicative of the start of each line of the image. Subsequently, as shown in FIG. 2, the image data is transmitted in synchronization with the vertical synchronizing signal. At this point, the pixel data of each line is transmitted from the upper side of the image toward the lower side thereof in synchronization with the vertical synchronizing signal. FIG. 2 shows an example in the case where an image having n pixels in a horizontal direction×m pixels (m lines) in a vertical direction is transmitted.

### (Step 2)

The auxiliary data buffer unit 104 temporarily stores the auxiliary data 134 separated in the SDI receiver unit 103, and then outputs the auxiliary data 134 to the system control unit 102 as buffered auxiliary data 136. In addition, the image data memory unit 105 temporarily stores the input image data 135 separated in the SDI receiver unit 103, and then outputs the input image data 135 to the common characteristic conversion unit 114 as buffered image data 137. The buffered image data 137 is outputted at a timing suitable for driving the liquid crystal panel unit 110.

### (Step 3)

The common characteristic conversion unit 114 acquires gradation characteristic information 142 included in the buffered auxiliary data 136 corresponding to the input image data from the system control unit 102, and converts the input image data having an arbitrary gradation characteristic to common gradation data 141 based on the gradation characteristic information 142. Specifically, the bit number and the gradation characteristic of the input image data are determined based on the gradation characteristic information. Subsequently, by using a conversion expression corresponding to the determination result, the input image data is converted to the common gradation data 141 in which the correspondence between the gradation value of the imaging data and the gradation value of the image data corresponds to the relationship represented by Expression 2. In Expression 2, X denotes the gradation value of the imaging data, while Y denotes the gradation value of the common gradation data. α denotes an arbitrary value.

[Math. 1]

Y=log₂(1+(2^{α}−1)×X) (Expression 2)

FIG. 3A shows the conversion from the input image data to the common gradation data. In the example of FIG. 3A, the input image data is image data in which the dynamic range is the gradation range corresponding to the gradation range 0 to 100% of the imaging data, the gradation value is the 8-bit gradation value (0 to 255), and the gradation characteristic is the gamma 2.2 characteristic. In the example of FIG. 3A, such input image data is converted to the common gradation data in which the dynamic range is the gradation range corresponding to the gradation range 0 to 100% of the imaging data, the gradation value is the 12-bit gradation value, and the gradation characteristics is the Log characteristic. In the case where the dynamic range is the gradation range corresponding to the gradation range 0 to 1000% of the imaging data, the common gradation data can have the gradation value of 0 to 4095. However, the dynamic range of the input image data is the gradation range corresponding to the gradation range 0 to 100% of the imaging data, and hence the maximum value of the gradation value that the common gradation data can have is limited to a value smaller than 4095.

Herein, white of the imaging data having the gradation value of 100% has the gradation value when an image of a white board that reflects light is taken.

Note that the correspondence between the gradation value of the imaging data and the gradation value of the input image data may be determined based on the gradation characteristic information. Subsequently, the gradation value of the imaging data corresponding to the gradation value of the input image data may be calculated from the determination result, and the gradation value of the common gradation data corresponding to the calculated gradation value of the imaging data may be calculated by using Expression 2.

### (Step 4)

The system control unit 102 generates the LUT based on the D range information (the dynamic range of the input image data) included in the buffered auxiliary data 136, and outputs the generated LUT. In the present embodiment, it is assumed that each of the pixel data of the common gradation data (the input gradation value) and the pixel data of the post-gradation conversion data (the output gradation value) is the 12-bit data and has the value of 0 to 4095. In the present embodiment, the one-dimensional lookup table having n lattice points that are discretely provided (the one-dimensional lookup table of n words (word bit width of 12 bits)) is generated. Specifically, the system control unit 102 generates n lattice points based on the D range information (determines the positions of n lattice points). Subsequently, the system control unit 102 outputs input value data 132 and output value data 133 to the gradation characteristic conversion unit 106. The input value data 132 is data indicative of the input gradation value of each determined lattice point (the gradation value in the gradation characteristic of the common gradation data). The output value data 133 is data indicative of the output gradation value of each determined lattice point (the gradation value in the post-gradation conversion data).

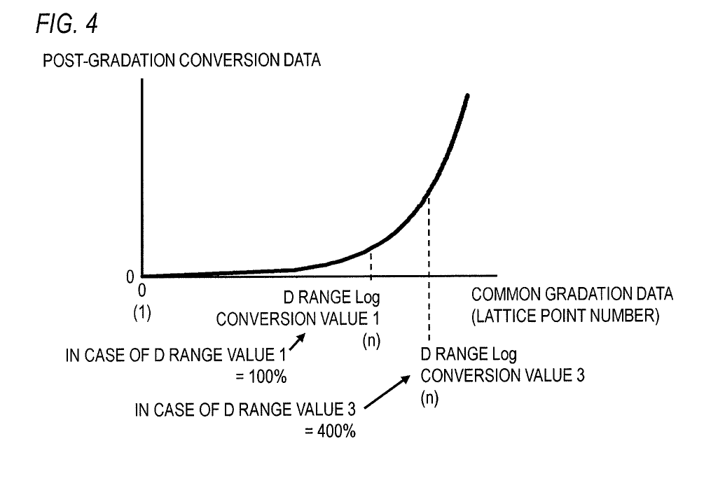

In the gradation characteristic conversion unit 106, as shown in FIG. 4, the common gradation data having the Log characteristic is converted to the post-gradation conversion data having the gradation characteristic suitable for driving the liquid crystal panel unit 110. As described above, in the present embodiment, the common gradation data is converted to the post-gradation conversion data having the gamma characteristic defined by ITU-R BT. 709 (the gradation characteristic as substantially a 2.2 power function).

At this point, as in the related art, when the input gradation value of the lattice point is a fixed value and only the output gradation value of the lattice point can be changed, there are cases where it is not possible to perform the conversion of the gradation characteristic of the input image data with high accuracy depending on the dynamic range of the input image data.

Specifically, in the case where the dynamic range of the input image data is narrow, there are cases where the lattice point is allocated outside the dynamic range and a sufficient number of the lattice points are not allocated inside the dynamic range. As a result, there are cases where a conversion error is increased and an image interference such as contouring or the like is generated. In particular, visual characteristics of a person are sensitive to a change on a dark part side, and hence there are cases where the image interference on the dark part side becomes conspicuous.

To cope with this, in the present embodiment, the gradation range to which the lattice point is allocated is determined based on the dynamic range of the input image data. Subsequently, n lattice points are generated such that the lower-end lattice point is generated at the minimum gradation value of the dynamic range of the input image data or in the vicinity thereof, and the upper-end lattice point is generated at the maximum gradation value of the dynamic range or in the vicinity thereof.

The n lattice points are generated in the manner shown below.

In the present embodiment, a D range value as the maximum gradation value in the gradation range of the imaging data corresponding to the dynamic range of the input image data and a value within the range 0 to 1000% of the gradation value that the imaging data can have is included in the buffered auxiliary data 136 as the D range information.

First, the system control unit 102 determines the gradation value of the common gradation data corresponding to the D range value (a D range Log conversion value) from the D range value. As shown in FIG. 3B, in the case where a D range value 1=100% is included in the buffered auxiliary data 136, it is determined that a D range Log conversion value 1 is the gradation value of the common gradation data corresponding to the D range value 1. In the case where a D range value 2=1000% is included in the buffered auxiliary data 136, it is determined that a D range Log conversion value 2 is the gradation value of the common gradation data corresponding to the D range value 2.

The gradation value of the input image data corresponding to a value larger than the D range value is not inputted from the imaging apparatus, and the upper limit value of the common gradation data is limited to the D range Log conversion value. Accordingly, the system control unit 102 determines the gradation range from the gradation value 0 of the common gradation data to the D range Log conversion value, i.e., the gradation range of the common gradation data corresponding to the dynamic range of the input image data as the generation range of the lattice point. The gradation value 0 of the common gradation data is the gradation value of the common gradation data corresponding to the gradation value 0 of the imaging data.

Subsequently, the system control unit 102 determines the input gradation values of the n lattice points based on the determination result of the generation range of the lattice point. In the present embodiment, the input gradation values of the n lattice points are determined such that the minimum value is 0 and the maximum value is the D range Log conversion value. As shown in FIG. 4, in the case where the D range value 1=100% is included in the buffered auxiliary data 136, the input gradation values of the n lattice points are determined such that the gradation value 0 is the input gradation value of the first lattice point and the D range Log conversion value 1 is the input gradation value of the n-th lattice point. In the case where a D range value 3=400% is included in the buffered auxiliary data 136, the input gradation values of the n lattice points are determined such that the gradation value 0 is the input gradation value of the first lattice point and a D range Log conversion value 3 is the input gradation value of the n-th lattice point. The first lattice point is a lower-end lattice point and the n-th lattice point is an upper-end lattice point. With this, it is possible to generate the effective lattice points for input gradation data irrespective of the dynamic range of the input image data. Consequently, it is possible to perform the conversion of the gradation characteristic of the input image data with high accuracy irrespective of the dynamic range of the input image data, and reduce image quality degradation caused by the conversion error (specifically an interpolation error when interpolation between the lattice points is performed).

Next, the system control unit 102 outputs the input value data 132 indicative of the determined n input gradation values described above and the output value data 133 indicative of the n output gradation values corresponding to the determined n input gradation values (the output gradation values of the n lattice points) to the gradation characteristic conversion unit 106. The output gradation value of the lattice point is calculated by using, e.g., a specific function that represents the correspondence between the input gradation value and the output gradation value. The processing for determining the input gradation value and the output gradation value corresponding to the input gradation value corresponds to processing for generating the lattice point. With the completion of generation of the n lattice points, the LUT is completed.

Note that the calculation method of the output gradation value is not limited to the above method. For example, it is possible to calculate the output gradation value of the lattice point by assigning the input gradation value of the lattice point to Y in Expression 2 described above and solving a system of equations of Expression 1 and Expression 2.

Note that, although the interval between the lattice points is not particularly limited (the interval is not necessarily a regular interval), as shown in FIG. 5A, it is preferable to generate the n lattice points that equally divide the generation range of the lattice point. If the lattice points are generated in the above manner, it is possible to determine the positions of the lattice points using simple processing. FIG. 5A (and each of FIGS. 5B to 5D described later) shows an example in the case where the number of lattice points n=17 is satisfied.

In addition, in consideration of the sensitiveness of the visual characteristics of a person to the change on the dark part side, it is preferable to generate the n lattice points such that the density of the lattice point is higher on a side where the gradation value is low than on a side where the gradation value is high. For example, it is preferable to generate the n lattice points in the manner shown in FIG. 5B. When the lattice points are generated in this manner, it is possible to further reduce the conversion error on the side where the gradation value is low, and further reduce the image quality degradation.

In addition, it is preferable that the gradation range not more than a specific gradation value in the gradation characteristic of the post-gradation conversion data is predetermined as the dark part, and the gradation range higher than the specific gradation value in the gradation characteristic of the post-gradation conversion data is predetermined as the bright part. Further, as shown in FIG. 5C, it is preferable to generate m (m is an integer not less than 1 and less than n) lattice points that equally divide, of the generation range of the lattice point, the gradation range corresponding to the dark part, and generate n-m lattice points that equally divide, of the generation range, the gradation range corresponding to the bright part. By generating the lattice points in this manner, it is possible to determine the positions of the lattice points using simple processing, and further reduce the image quality degradation. In the case where the maximum range of a display brightness (the maximum range of the brightness that can be reproduced on the screen) is set to 0.1 to 100 cd, the dark part is, e.g., the gradation range of the post-gradation conversion data corresponding to the range 0.1 to 10 cd of the display brightness. The bright part is, e.g., the gradation range of the post-gradation conversion data corresponding to the range 10 to 100 cd of the display brightness. FIG. 5C shows an example in the case where the number of divisions of the dark part m=9 is satisfied.

In addition, as shown in FIGS. 5A to 5D, n lattice points may be generated inside the dynamic range of the input image data and, as shown in FIG. 5E, n lattice points including the lattice point outside the dynamic range of the input image data may also be generated.

Note that, in the present embodiment, although the description has been given of the example in the case where the gradation value of the imaging data corresponding to the minimum gradation value of the dynamic range of the input image data is the minimum value (0%) of the gradation value that the imaging data can have, the present invention is not limited thereto. The gradation value of the imaging data corresponding to the minimum gradation value of the dynamic range of the input image data may be larger than 0%.

Note that the determination method of the generation range of the lattice point is not limited to the above method. For example, the D range information may be information indicative of the dynamic range of the input image data (the maximum gradation value and the minimum gradation value of the dynamic range of the input image data) instead of the D range value. Further, the gradation range of the common gradation data corresponding to the dynamic range of the input image data may be determined from the dynamic range of the input image data, and the generation range of the lattice point may be determined based on the determination result. In addition, the D range information may be information indicative of the gradation range of the imaging data corresponding to the dynamic range of the input image data (the maximum gradation value and the minimum gradation value of the gradation range of the imaging data corresponding to the dynamic range of the input image data). Further, the gradation range of the common gradation data corresponding to the dynamic range of the input image data may be determined from such information, and the generation range of the lattice point may be determined based on the determination result.

Note that, in the present embodiment, the gradation range of the common gradation data corresponding to the dynamic range of the input image data has been determined as the generation range of the lattice point. In addition, in the present embodiment, the lower-end lattice point has been generated at the minimum gradation value of the dynamic range of the input image data, and the upper-end lattice point has been generated at the maximum gradation value of the dynamic range. However, the generation range of the lattice point and the positions of the upper-end and lower-end lattice points are not limited thereto. For example, the lower-end lattice point may be generated in the vicinity of the minimum gradation value of the dynamic range, and the upper-end lattice point may be generated in the vicinity of the maximum gradation value of the dynamic range. Specifically, the gradation range from a value obtained by adding a specific value to the gradation value of the common gradation data corresponding to the minimum gradation value of the dynamic range to a value obtained by adding a specific value to the gradation value of the common gradation data corresponding to the maximum gradation value of the dynamic range may be determined as the generation range of the lattice point. In addition, the lower-end lattice point may be generated at the value obtained by adding the specific value to the gradation value of the common gradation data corresponding to the minimum gradation value of the dynamic range, and the upper-end lattice point may be generated at the value obtained by adding the specific value to the gradation value of the common gradation data corresponding to the maximum gradation value of the dynamic range.

Note that, in the present embodiment, although the generation range of the lattice point has been represented by the gradation range in the gradation characteristic of the common gradation data, the present invention is not limited thereto. For example, the generation range of the lattice point may be represented by the gradation range in the gradation characteristic of the input image data, or the generation range of the lattice point may also be represented by the gradation range in the gradation characteristic of the post-gradation conversion data. In addition, n lattice points that equally divide the generation range as the gradation range in the gradation characteristic of the input image data may be generated, or n lattice points that equally divide the generation range as the gradation range in the gradation characteristic of the post-gradation conversion data may also be generated.

### (Step 5)

The gradation characteristic conversion unit 106 converts, on the basis of the input value data 132 and output value data 133, the buffered image data 137 to post-gradation conversion data 138, and outputs the post-gradation conversion data 138 to the image processing unit 107.

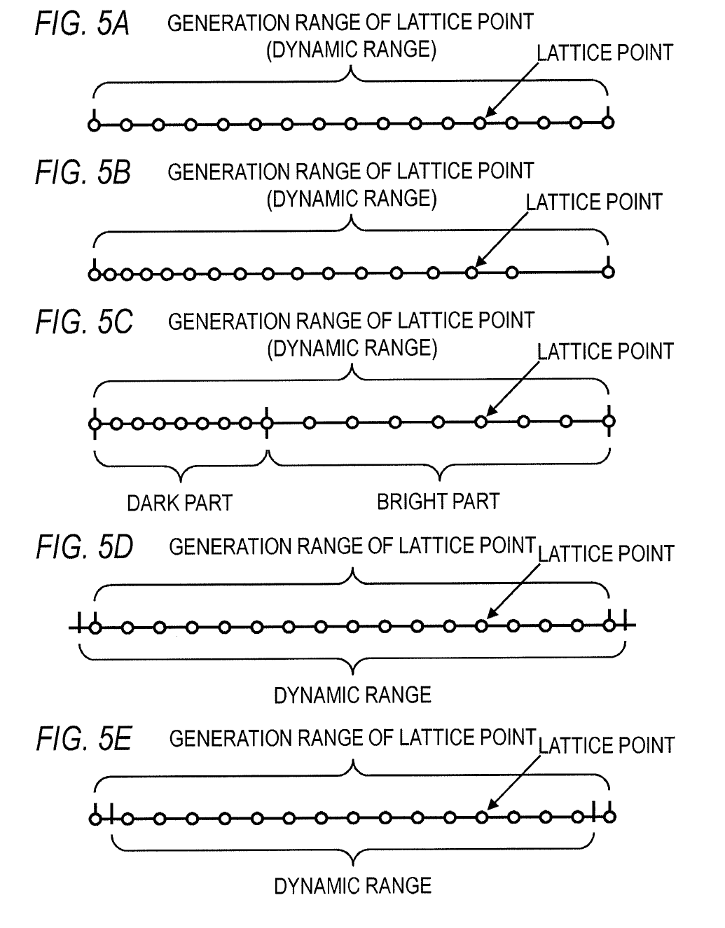

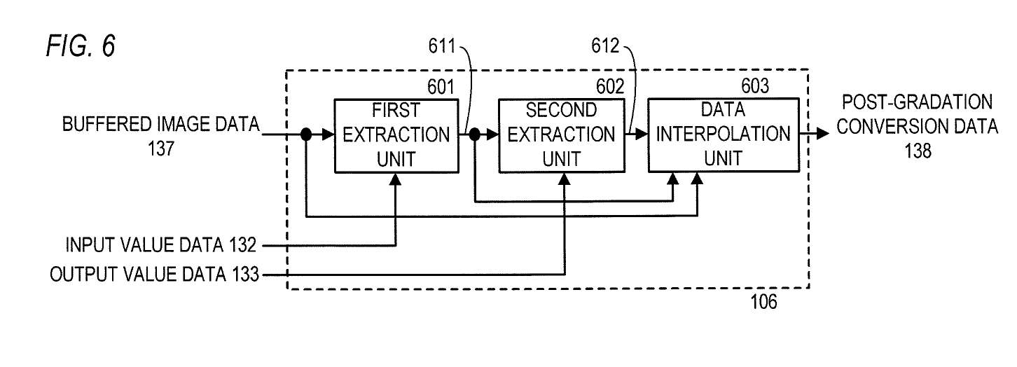

As shown in FIG. 6, the gradation characteristic conversion unit 106 includes a first extraction unit 601, a second extraction unit 602, and a data interpolation unit 603.

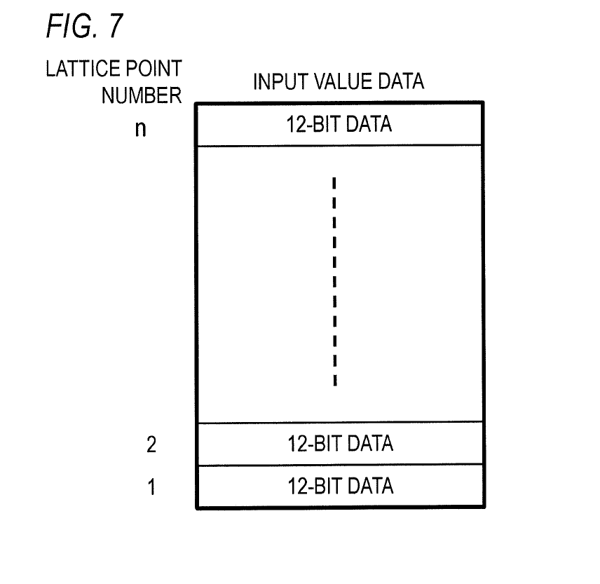

The first extraction unit 601 extracts two input gradation values (the input gradation values of the lattice points) and the numbers of two lattice points (lattice point numbers) corresponding to the two input gradation values from the input value data 132 in accordance with the gradation value of the buffered image data 137. Subsequently, the first extraction unit 601 outputs first extraction data 611 indicative of the extracted input gradation values and lattice point numbers. Specifically, in the case where the gradation value of the buffered image data 137 is A, input gradation values B and C that satisfy B≦A<C and lattice point numbers j and j+1 corresponding to the input gradation values B and C are extracted from the input value data 132. The lattice point number j is a numerical value not less than 1 and not more than n that is increased toward the high gradation side. FIG. 7 is a schematic diagram of the input value data 132. The output value data 133 also has a similar configuration.

The second extraction unit 602 extracts from the output value data 133 output gradation values D and E corresponding to the lattice point numbers j and j+1 (the output gradation values of the lattice points) extracted in the first extraction unit 601. Subsequently, the second extraction unit 602 outputs second extraction data 612 indicative of the extracted output gradation values D and E.

The data interpolation unit 603 calculates an output gradation value F corresponding to the gradation value A of the buffered image data 137 by using the gradation value A of the buffered image data 137, the input gradation values B and C indicated by the first extraction data 611, and the output gradation values D and E indicated by the second extraction data 612. Subsequently, the data interpolation unit 603 outputs the output gradation value F as the gradation value of the post-gradation conversion data 138. Specifically, the output gradation value F is calculated by using Expression 3 shown below. That is, in the present embodiment, in the case where the lattice point having the gradation value A of the buffered image data 137 as the input gradation value is present, the gradation value A is converted to the output gradation value of the lattice point. On the other hand, in the case where the lattice point having the gradation value A of the buffered image data 137 as the input gradation value is not present, the output gradation value corresponding to the gradation value A is calculated by linear interpolation.

F=(E×(A−B)+D×(C−A))/(C−B) (Expression 3)

Note that, in the present embodiment, although the example in which the output gradation value between the lattice points is calculated by the linear interpolation has been shown, the interpolation method is not limited thereto. The output gradation value between the lattice points may also be calculated by using a high-order function. In addition, a function (a relational expression between the input gradation value and the output gradation value) corresponding to a part or all of the gradation range may be determined by using three or more lattice points, and the output gradation value may be calculated by using the determined function.

The liquid crystal panel unit 110 is a liquid crystal panel having a plurality of liquid crystal pixels arranged in a matrix. The liquid crystal pixels arranged in a horizontal direction are connected to a common scan line, and the liquid crystal pixels arranged in a vertical direction are connected to a common data line. By supplying selection data to the scan line, the liquid crystal pixels connected to the scan line (the liquid crystal pixels of one line) are selected as the target of transmittance control. Subsequently, by supplying corresponding pixel data to each of the selected liquid crystal pixels via the data line, the transmittance of each of the selected liquid crystal pixels is controlled. By performing the above control on all of the lines, the display of the entire screen is completed.

### (Step 6)

The panel correction unit 108 performs correction processing on post-image processing data 139 to generate post-correction processing data 140, and outputs the post-correction processing data 140 to the panel control unit 109. The correction processing is processing for correcting distortion in the transmittance of the liquid crystal pixel with respect to the image data of the liquid crystal panel unit 110.

### (Step 7)

The panel control unit 109 generates selection data and line pixel data based on the post-correction processing data 140, and outputs them. The selection data is data for selecting the liquid crystal pixels as the control target (the liquid crystal pixels of one line) from among the plurality of the liquid crystal pixels of the liquid crystal panel unit 110, and the selection data is outputted to the selection data supply unit 112. The line pixel data is pixel data supplied to the liquid crystal pixels (the liquid crystal pixels of one line) selected using the selection data, and is pixel data included in the post-correction processing data 140. The line pixel data is outputted to the pixel data supply unit 111. In the present embodiment, the selection data and the line pixel data are generated sequentially from the top of the screen on a per line basis, and are outputted.

### (Step 8)

The selection data supply unit 112 supplies the selection data to the scan line of the liquid crystal panel unit 110. With this, the liquid crystal pixels (the liquid crystal pixels of one line) as the control target are selected. In addition, the pixel data supply unit 111 supplies the line pixel data to the data line. With this, the transmittance of each of the liquid crystal pixels selected using the selection data is controlled to the transmittance corresponding to the pixel data (the post-correction processing data 140).

As described thus far, according to the present embodiment, the generation range of the n lattice points is controlled in accordance with the dynamic range of the input image data. With this, it is possible to generate the effective lattice points for the input gradation data irrespective of the dynamic range of the input image data. Accordingly, it is possible to perform the conversion of the gradation characteristic of the input image data with high accuracy irrespective of the dynamic range of the input image data, and reduce the image quality degradation caused by the conversion error.

Note that, in the present embodiment, although the description has been given of the example in which the LUT having the n lattice points each having the gradation value of the common gradation data as the input gradation value and the gradation value of the post-gradation conversion data as the output gradation value is generated, the LUT is not limited thereto. For example, the LUT having the n lattice points each having the gradation value of the input image data as the input gradation value and the gradation value of the post-gradation conversion data as the output gradation value may also be generated. In this case, the common characteristic conversion unit 114 is not necessary.

Note that, in the present embodiment, although the input image data has been assumed to be outputted from the imaging apparatus, the present invention is not limited thereto. For example, the input image data may be outputted from an apparatus other than the imaging apparatus (PC or the like), and may be acquired from a storage medium such as a semiconductor memory, magnetic disk, or optical disk.

### Second Embodiment

Hereinbelow, a description will be given of an image processing apparatus and a control method for the image processing apparatus according to a second embodiment of the present invention with reference to the drawings. In the present embodiment, an example in the case where the D range information indicative of the dynamic range of the input image data has not been acquired from the outside will be described.

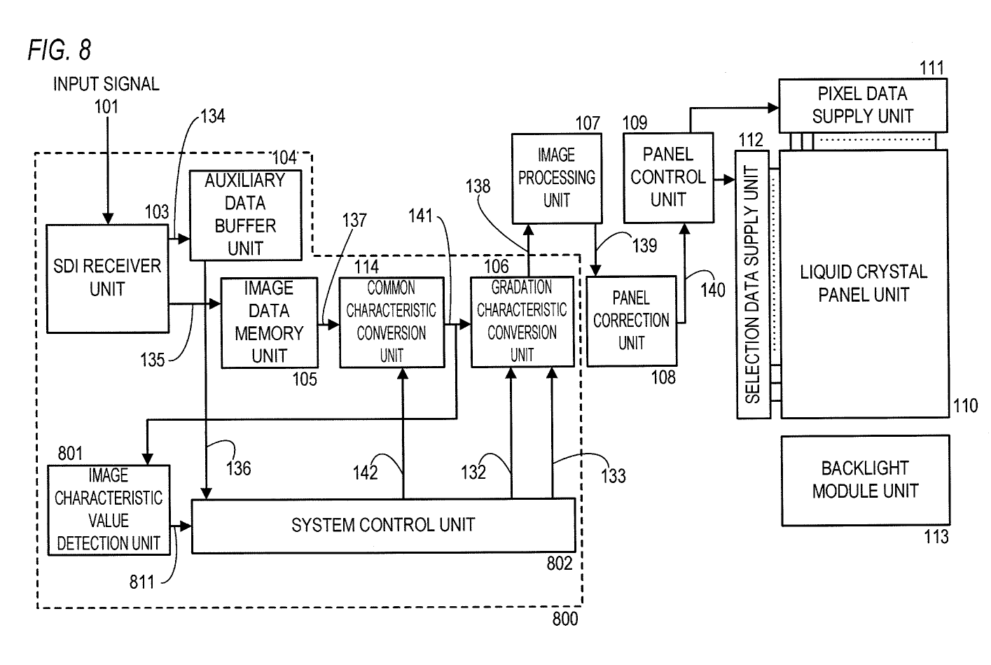

As shown in FIG. 8, a display apparatus according to the present embodiment includes an image processing apparatus 800, the image processing unit 107, the panel correction unit 108, the panel control unit 109, the liquid crystal panel unit 110, the pixel data supply unit 111, the selection data supply unit 112, and the backlight module unit 113. The image processing apparatus 800 includes a system control unit 802, the SDI receiver unit 103, the auxiliary data buffer unit 104, the image data memory unit 105, the common characteristic conversion unit 114, the gradation characteristic conversion unit 106, and an image characteristic value detection unit 801.

Note that the functional units having the same reference numerals as those of the functional units of the first embodiment (FIG. 1) have the same functions as those of the functional units of the first embodiment, and hence the description thereof will be omitted.

In the present embodiment, in the case where the D range information has not been acquired from the outside, the common characteristic conversion unit 114, the image characteristic value detection unit 801, and the system control unit 802 determine the dynamic range of the input image data based on the gradation value of the input image data.

The image characteristic value detection unit 801 detects the image characteristic value of the input image data. In the present embodiment, the image characteristic value detection unit 801 detects the image characteristic value from the common gradation data 141. Specifically, the maximum value of the gradation value of the common gradation data is detected as the image characteristic value on a per frame basis. The gradation value that the common gradation data can have when the dynamic range of the input image data is widest is 0 to 4095. Accordingly, the range that the image characteristic value can have when the dynamic range of the input image data is widest is 0 to 4095.

The image characteristic value detection unit 801 outputs an image characteristic value signal 811 indicative of the detected image characteristic value to the system control unit 802.

Note that the image characteristic value is not limited to the maximum value of the gradation value of the common gradation data. For example, the image characteristic value may be the minimum value of the gradation value of the common gradation data, or the minimum value and the maximum value of the gradation value of the common gradation data. In addition, the image characteristic value may also be the minimum value of the gradation value of the input image data, the maximum value of the gradation value of the input image data, or both of them.

The system control unit 802 generates the LUT based on the D range information included in the buffered auxiliary data 136 similarly to the system control unit 102 of the first embodiment.

Herein, there are cases where the auxiliary data is not inputted into the display apparatus, or the D range information is not included in the buffered auxiliary data 136. For example, the imaging apparatuses include the imaging apparatus that does not have the function of adding the auxiliary data to the image data, and the imaging apparatus that dose not have the function of including the D range information in the auxiliary data. The input signal inputted from such an imaging apparatus does not include the D range information, and the D range information corresponding to the input image data is not acquired from the outside.

To cope with this, in the present embodiment, in the case where the D range information corresponding to the input image data has not been acquired from the outside, the system control unit 802 performs dynamic range determination processing. The dynamic range determination processing is processing for determining the dynamic range of the input image data based on the image characteristic value detected in the image characteristic value detection unit 801. Subsequently, the system control unit 802 generates n lattice points based on the result of the dynamic range determination processing to generate the LUT.

A detailed description will be given of the dynamic range determination processing.

As described above, in the present embodiment, the image characteristic value is the maximum value of the gradation value of the common gradation data, and the pixel having the gradation value larger than the gradation value indicated by the image characteristic value does not exist in the common gradation data. Accordingly, there is no problem in regarding the gradation value indicated by the image characteristic value as the gradation value of the common gradation data corresponding to the maximum gradation value of the dynamic range of the input image data.

In addition, in the present embodiment, it is assumed that the minimum gradation value of an arbitrary dynamic range is a predetermined fixed value. Specifically, it is assumed that the gradation value of the common gradation data corresponding to the minimum gradation value of the dynamic range of the input image data is 0 irrespective of the dynamic range of the input image data.

In the present embodiment, in the case where the D range information has not been acquired, the gradation range from the gradation value 0 of the common gradation data to the gradation value indicated by the image characteristic value is determined as the gradation range of the common gradation data corresponding to the dynamic range of the input image data. Subsequently, the LUT is generated based on the determination result by the same method as that in the first embodiment.

Note that, in the case where the image characteristic value is the maximum value of the gradation value of the input image data, the gradation range from the minimum gradation value of the dynamic range of the input image data to the maximum value thereof may be appropriately determined as the dynamic range of the input image data. Subsequently, based on the determination result, the LUT may be appropriately generated. For example, the gradation range of the common gradation data corresponding to the determined dynamic range may be appropriately determined, and the LUT may be appropriately generated based on the determination result.

Note that the minimum gradation value of the arbitrary dynamic range is not necessarily the fixed value.

In the case where neither the minimum gradation value nor the maximum gradation value of the arbitrary dynamic range is the fixed value, the minimum value and the maximum value of the gradation value of the common gradation data may be detected as the image characteristic value. Subsequently, the range from the minimum value of the gradation value of the common gradation data to the maximum value of the gradation value of the common gradation data may be appropriately determined as the gradation range of the common gradation data corresponding to the dynamic range of the input image data. In addition, the minimum value and the maximum value of the gradation value of the input image data may be detected as the image characteristic value. Further, the range from the minimum value of the gradation value of the input image data to the maximum value of the gradation value of the input image data may be determined as the dynamic range of the input image data.

In the case where the minimum gradation value of the arbitrary dynamic range is not the fixed value and the maximum gradation value of the arbitrary dynamic range is the fixed value, the minimum value of the gradation value of the common gradation data may be appropriately determined as the image characteristic value. Subsequently, the range from the minimum value of the gradation value of the common gradation data to the gradation value of the common gradation data corresponding to the maximum gradation value of the dynamic range of the input image data may be appropriately determined as the gradation range of the common gradation data corresponding to the dynamic range of the input image data. In addition, the minimum value of the gradation value of the input image data may be determined as the image characteristic value. Further, the range from the minimum value of the gradation value of the input image data to the maximum gradation value of the dynamic range of the input image data may be determined as the dynamic range of the input image data.

As described thus far, according to the present embodiment, in the case where the D range information has not been acquired from the outside, the dynamic range of the input image data is determined based on the gradation value of the input image data, and the LUT is generated based on the determination result. With this, even in the case where the D range information has not been acquired from the outside, it is possible to generate the effective lattice points for the input gradation data irrespective of the dynamic range of the input image data. As a result, even in the case where the D range information has not been acquired from the outside, it is possible to perform the conversion of the gradation characteristic of the input image data with high accuracy irrespective of the dynamic range of the input image data, and reduce the image quality degradation caused by the conversion error.

Note that, in the present embodiment, in the case where the D range information has not been acquired from the outside, it is assumed that the dynamic range determination processing is performed and the LUT is generated based on the result of the dynamic range determination processing. In addition, in the case where the D range information has been acquired from the outside, it is assumed that the LUT is generated by the same method as that in the first embodiment. However, the generation method of the LUT is not limited thereto. The dynamic range determination processing may be performed irrespective of whether or not the D range information has been acquired from the outside, and the LUT may be generated based on the result of the dynamic range determination processing.

Note that the dynamic range determination processing may be performed in a functional unit different from the system control unit 802. For example, the image processing apparatus may further include a determination unit that performs the dynamic range determination processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s).

This application claims the benefit of Japanese Patent Application No. 2013-096349, filed on May 1, 2013, which is hereby incorporated by reference herein in its entirety.

What is claimed is:

1. An image processing apparatus comprising:
a generation unit configured to generate a lookup table having a specific number of lattice points for converting input image data into display image data having a different gradation characteristic by using a predetermined expression; and
a conversion unit configured to convert the input image data into the display image data by using the lookup table generated by the generation unit, wherein
the generation unit determines positions of the specific number of lattice points in accordance with a dynamic range of the input image data.

2. The image processing apparatus according to claim 1, wherein
the generation unit generates the specific number of lattice points such that a lower-end lattice point is generated at a minimum gradation value of the dynamic range of the input image data or in a vicinity of the minimum gradation value thereof, and an upper-end lattice point is generated at a maximum gradation value of the dynamic range or in a vicinity of the maximum gradation value thereof.

3. The image processing apparatus according to claim 1, wherein
the generation unit generates the specific number of lattice points such that a density of the lattice points is higher on a side where a gradation value is low than on a side where the gradation value is high.

4. The image processing apparatus according to claim 1, wherein
the generation unit generates the specific number of lattice points that equally divide a generation range, which is a gradation range in which the specific number of lattice points are generated.

5. The image processing apparatus according to claim 1, wherein
a gradation range not more than a specific gradation value in the gradation characteristic of the display image data is predetermined as a dark part, and a gradation range more than the specific gradation value in the gradation characteristic of the display image data is predetermined as a bright part,
the specific number of lattice points are n (n is an integer not less than 2) lattice points, and
the generation unit generates m (m is an integer not less than 1 and less than n) lattice point that equally divides, of a generation range, which is a gradation range in which the specific number of lattice points are generated, a gradation range that corresponds to the dark part, and generates n-m lattice point that equally divides, of the generation range, the gradation range that corresponds to the bright part.

6. The image processing apparatus according to claim 1, wherein
the specific number of lattice points are generated inside the dynamic range.

7. The image processing apparatus according to claim 1, wherein
the specific number of lattice points include a lattice point outside the dynamic range.

8. The image processing apparatus according to claim 1, further comprising:
an acquisition unit configured to acquire information indicative of the dynamic range of the input image data.

9. The image processing apparatus according to claim 1, further comprising:
a determination unit configured to determine the dynamic range of the input image data based a gradation value of the input image data.

10. The image processing apparatus according to claim 9, wherein
a minimum gradation value of the arbitrary dynamic range is a predetermined fixed value, and
the determination unit determines a gradation range from the minimum gradation value to a maximum value of the gradation value of the input image data as the dynamic range of the input image data.

11. The image processing apparatus according to claim 9, wherein
the determination unit determines a gradation range from a minimum value of the gradation value of the input image data to a maximum value of the gradation value of the input image data as the dynamic range of the input image data.

12. A control method for an image processing apparatus comprising:
a generation step of generating a lookup table having a specific number of lattice points for converting input image data into display image data having a different gradation characteristic by using a predetermined expression; and
a conversion step of converting the input image data into the display image data by using the lookup table generated in the generation step, wherein
positions of the specific number of lattice points are determined in accordance with a dynamic range of the input image data in the generation step.

13. The control method according to claim 12, wherein
in the generation step, the specific number of lattice points are generated such that a lower-end lattice point is generated at a minimum gradation value of the dynamic range of the input image data or in a vicinity of the minimum gradation value thereof, and an upper-end lattice point is generated at a maximum gradation value of the dynamic range or in a vicinity of the maximum gradation value thereof.

14. The control method according to claim 12, wherein
in the generation step, the specific number of lattice points are generated such that a density of the lattice points is higher on a side where a gradation value is low than on a side where the gradation value is high.

15. The control method according to claim 12, wherein
in the generation step, the specific number of lattice points that equally divide a generation range, which is a gradation range in which the specific number of lattice points are generated, are generated.

16. The control method according to claim 12, wherein
a gradation range not more than a specific gradation value in the gradation characteristic of the display image data is predetermined as a dark part, and a gradation range more than the specific gradation value in the gradation characteristic of the display image data is predetermined as a bright part,
the specific number of lattice points are n (n is an integer not less than 2) lattice points, and
in the generation step, m (m is an integer not less than 1 and less than n) lattice point that equally divides, of a generation range, which is a gradation range in which the specific number of lattice points are generated, a gradation range that corresponds to the dark part, are generated, and n-m lattice point that equally divides, of the generation range, the gradation range that corresponds to the bright part, are generated.

17. The control method according to claim 12, wherein
the specific number of lattice points are generated inside the dynamic range.

18. The control method according to claim 12, wherein
the specific number of lattice points include a lattice point outside the dynamic range.

19. The control method according to claim 12, further comprising:
an acquisition step of acquiring information indicative of the dynamic range of the input image data.

20. The control method according to claim 12, further comprising:
a determination step of determining the dynamic range of the input image data based a gradation value of the input image data.

21. The control method according to claim 20, wherein
a minimum gradation value of the arbitrary dynamic range is a predetermined fixed value, and
in the determination step, a gradation range from the minimum gradation value to a maximum value of the gradation value of the input image data is determined as the dynamic range of the input image data.

22. The control method according to claim 20, wherein
in the determination step, a gradation range from a minimum value of the gradation value of the input image data to a maximum value of the gradation value of the input image data is determined as the dynamic range of the input image data.

23. A non-transitory computer readable medium that stores a program, wherein the program causes a computer to execute the method according to claim 12.
